(19) United States
(12) Patent Application Publication
(10) Pub. No.: US 2019/0089139 A1
(43) Pub. Date: Mar. 21, 2019

(54) NETWORK CABLE MANAGEMENT DEVICE

(71) Applicant: YOUHUNG INTERNATIONAL VIEW CO., LTD., New Taipei (TW)

(72) Inventor: Tzu-Rung TSAY, New Taipei (TW)

(21) Appl. No.: 15/710,992

(22) Filed: Sep. 21, 2017

(51) Int. Cl. H02G 1/14; F16L 3/02

(52) U.S. Cl. CPC H02G 1/14; F16L 3/02

(57) ABSTRACT

A network cable management device includes a main body which is a columnar body and has one or both ends manufactured into a conical tapered end, and a grip portion formed at the outer periphery of the main body and provided for facilitating a user to grip the main body, a plurality of clip slots which are radially distributed and axially penetrated through the main body, and each clip slot having a cable management hole, and an opening formed at an outer end of the cable management hole. A network cable is embedded from the opening of each clip slot into each cable management hole, so that many network cables can be arranged neatly, and the tapered end drives the network cables to be convergent towards the axis to facilitate tying the cables. In a combing operation of the network cables, a smaller resistance is produced. The invention skillfully integrates the clip slots with the grip portion to achieve the convenient and effort-saving effect.

### BACKGROUND OF THE INVENTION

### (a) Field of the Invention

The present invention relates to a cable management device, more particularly to the network cable management device having a plurality of clip slots radially distributed in a main body of the device and capable of arranging network cables neatly as well as performing a cable combing operation easily.

### (b) Description of the Related Art

At present, most business units, companies or governmental departments rely on computers to handle their business, and most manufacturing machines or process equipments are connected to a controller through the computers for automated operations. Therefore, many network cables are connected to a machine room which is provided for putting computer hosts or servers. Since the cables are placed randomly, it is difficult to find a specific line, and each line is not fixed and may be extended anywhere or even occupy a walkway, therefore the space of the engine room cannot be utilized effectively.

In view of the aforementioned drawbacks, related manufacturers have developed various types of network cable management devices to overcome the aforementioned drawbacks, and some of these devices are described below. With reference to FIGS. 1A and 1B for a porous columnar network hub as disclosed in R.O.C. Pat. No. M407552, the porous columnar network hub comprises a clip 910 which is substantially in an octagonal columnar shape, and the clip 910 has a plurality of through holes 920 configured to be parallel to the axis of the clip 910 and provided for passing a plurality of cables C respectively to fix each cable C into its position and protecting and preventing the cables from being worn out or damaged. However, a plug or a connector (not shown in the figure) at an end of the cable C must be removed first before the end of the cable can be passed through the through hole 920, and then the plug or connector is reinstalled after the end of the cable is passed through the through hole 920 in an application such porous columnar network hub. Obviously, such application is very inconvenient.

With reference to FIGS. 2A and 2B for a network cable tying device as disclosed in U.S. Pat. Nos. 7,959,113 and 7,600,721, the network cable tying device comprises an inner fitting 930 having a plurality of horizontal pockets 931 axially extended from the inner fitting 930, a first outer jacket half 941 and a second outer jacket half 942 that can be combined by snapping and covered onto the external periphery of the inner fitting 930. When use, many cables C are embedded into the pockets 931 respectively, and then the second outer jacket half 942 is snapped to fix each cable C to its position, so that the cables C can be arranged neatly without tangling with one another. In an application of such network cable tying device, it is not necessary to remove the plug or connector, but simply embeds any part of each cable into the respective pocket 931. However, both left and right sides of the horizontal pocket 931 are not completely symmetrical with respect to each other, so that the resistances on the left and right sides are not even, and the inner fitting 930 is in an irregular spine-like shape and cannot be held by hand easily. Therefore, it is necessary to combine the first and second outer jacket halves 941, 942 into a housing provided for a user to hold by hand. However, the aforementioned two network cable tying devices requires users to install and re-install the first and second outer jacket halves 941, 942 in order to put the cable C into the pocket 931 or remove the cable C from the pocket 931, and such application is very inconvenient. Since the inner fitting 930 has a large end surface, therefore a larger resistance is produced while moving the cables C, and the combing operation of the cables C cannot be done easily.

In view of the drawbacks of the aforementioned prior arts, it is a main subject for related manufacturers to provide a convenient network cable management device, so that users can embed the cables into the hub neatly. When the cables are tangled and messy, the hub can be used to comb the cables quickly, and thus hubs become very popular.

### SUMMARY OF THE INVENTION

Therefore, it is a primary objective of the present invention to provide a network cable management device, wherein many network cables can be embedded into the hub and arranged neatly without the need of removing the plug or connector of the cable, and the cables can be tied by a cable tie, so that the cables will not be tangled, and the clip slot and grip portion can be integrated skillfully, so that the network cable management device can perform the network cable combing operation easily and achieve the convenient and effort-saving effect.

A further objective of the invention is to provide a network cable management device which is lightweight and has low material cost.

According to the invention, a network cable management device comprises:

a main body, being a columnar body, and having a first end and a second end configured to be corresponsive to the first end, and at least one of the first and second ends being a conical first tapered end;

a grip portion, disposed at the outer periphery between the first end and the second end of the main body, and having a predetermined length provided for being held by a user's hand; and

a plurality of clip slots, using the center of the main body as the axis, and having a closed side end and being radially distributed at the periphery of the main body and axially penetrated through both ends of the main body, and each clip slot at least having a cable management hole, and an outer end extended to a surface of the grip portion to form an opening.

The network cables with a predetermined quantity are embedded into the cable management hole through the openings of the clip slots respectively, and the network cables can be arranged without being staggered, and the first tapered end keeps the network cable to be convergent towards the axis.

According to the invention, the network cable management device further comprises a second tapered end disposed on an opposite end of the first tapered end of the main body and configured to be symmetrical with respect to the first tapered end, and a relatively smaller resistance is produced when the main body performs a combining operation of the network cables repeatedly.

According to the invention, the network cable management device further comprises a plurality of fixing wings formed between the plurality of clip slots, and each fixing wing is made into a hollow member, and the axis of the main body also forms a hollow body to reduce the weight and the material cost of the main body.

The network cable management device according to the invention achieves the following advantages:

1. The clip slots 21 are radially distributed at the periphery of the main body 10, and penetrated through both ends of the main body 10 axially (in the X-X direction), so that the network cables C can be distributed uniformly, and the application does not require the removal of the plug or connector of the cable, but any part of the cable C can be embedded into the cable management hole 22 of each clip slot 21, so that many network cables C can be arranged neatly.

2. Further, one or both ends of the present invention is manufactured into a conical tapered end, so that when the network cable C is put into the cable management hole 22 at the first tapered end 11 or second tapered end 12, the network cable C will be converged automatically towards the axis 14. Since the middle of the network cables C has a smaller gap, therefore the cables can be tied by a cable tie T conveniently to prevent them from being tangled or scattered randomly.

3. According to the invention, the grip portion 13 is disposed at the outer periphery of the main body and provided for facilitating users to grip. One or both ends of the grip portion 13 are manufactured into a tapered end 11/12, so that a smaller resistance is produced when moving the network cables C, and the combing operation of the network cables C can be performed easily.

4. According to the invention, each fixing wing is made into a hollow member, and the axis of the main body also forming a hollow body to reduce the weight and the material cost of the main body.

### BRIEF DESCRIPTION OF THE FIGURES

FIG. 1A is a perspective view of a conventional network cable hub;

FIG. 1B is a schematic view of an application of a conventional network cable hub;

FIG. 2A is a schematic view of a cable tying device as disclosed in U.S. Pat. No. 7,959,113;

FIG. 2B is a schematic view of an application of a cable tying device as disclosed in U.S. Pat. No. 7,959,113;

FIG. 3A is a perspective view of a first preferred embodiment of the present invention;

FIG. 3B is a front view of the first preferred embodiment of the present invention;

FIG. 3C is a cross-sectional view of Section 3C-3C of FIG. 3B;

FIG. 3D is a cross-sectional view of another embodiment as depicted in FIG. 3C;

FIG. 4A is a perspective view of a second preferred embodiment of the present invention;

FIG. 4B is a front view of the second preferred embodiment of the present invention;

FIG. 5 is a schematic view of an application of the second preferred embodiment of the present invention; and

FIG. 6 is a schematic view of performing a cable combing operation in accordance with the second preferred embodiment of the present invention.

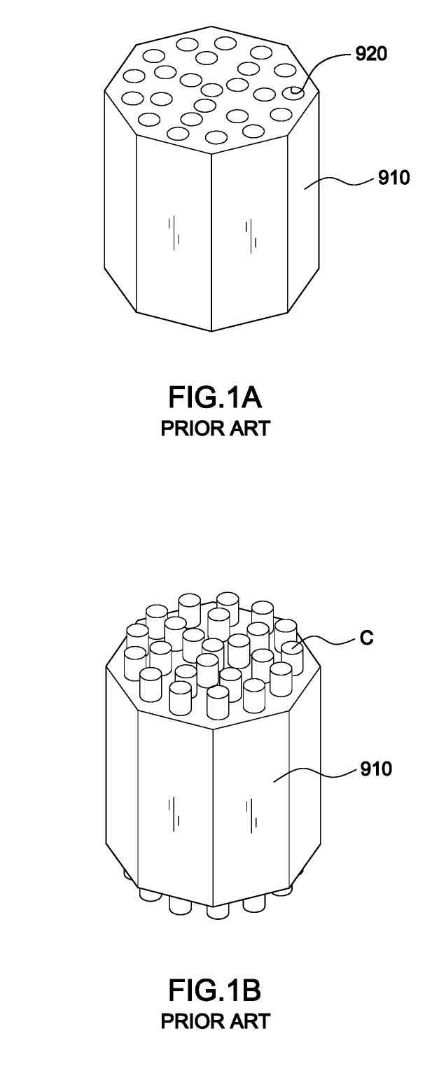

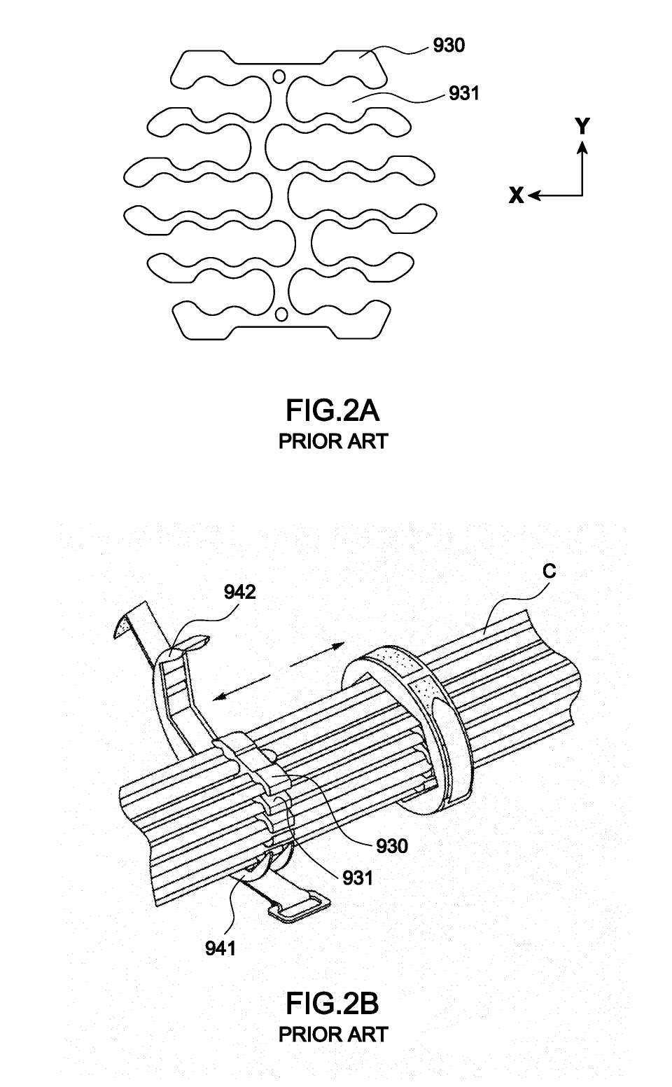

### DETAILED DESCRIPTION OF THE PREFERRED EMBODIMENT

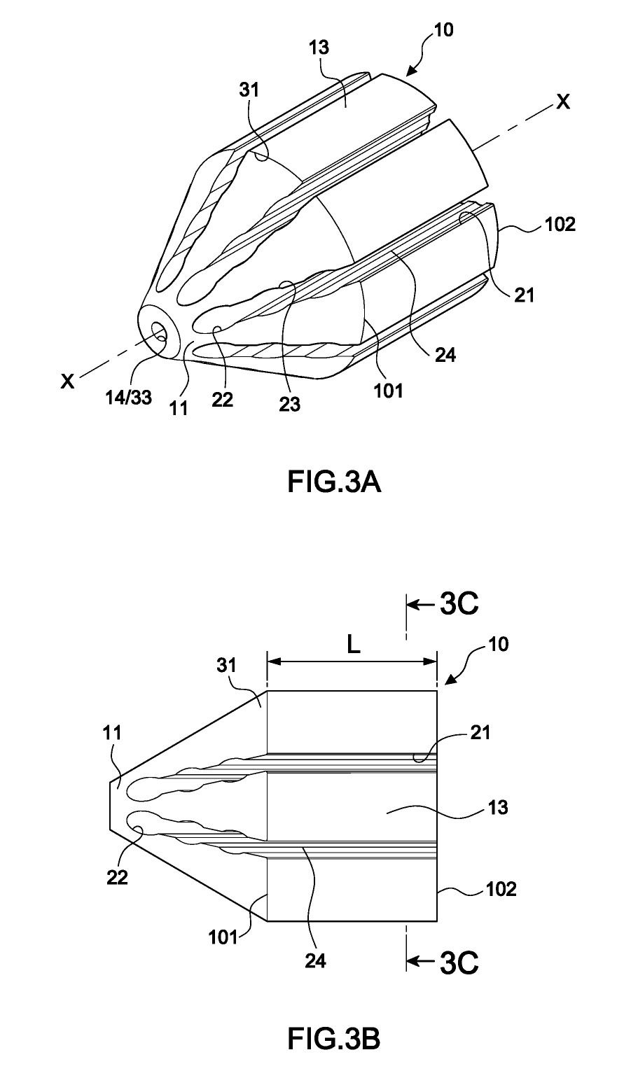

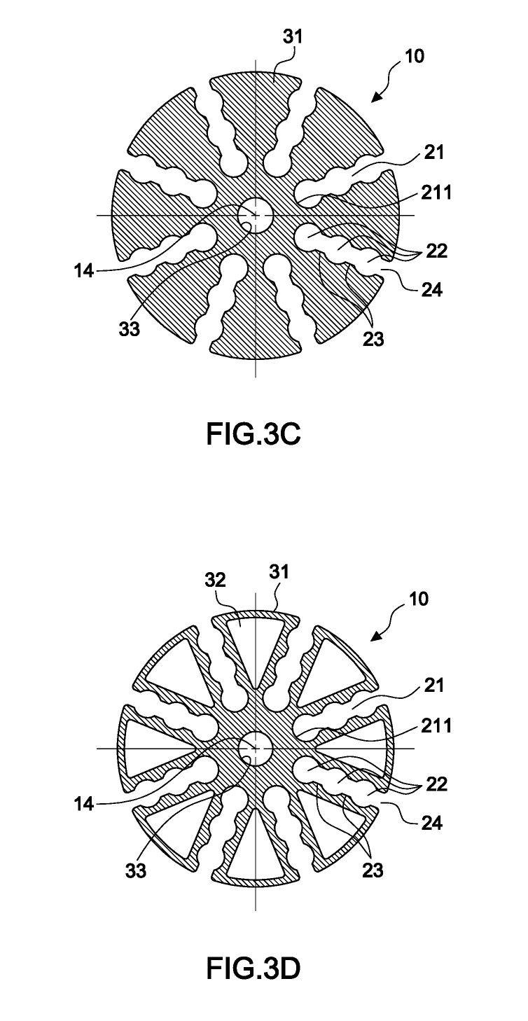

With reference to FIGS. 3A-3C for a network cable management device in accordance with the first preferred embodiment of the present invention network, the network cable management device comprises the following components:

A columnar main body 10 has a first end 101 and a second end 102 configured to be corresponsive to the first end, and at least one of the first end 101 and second end 102 is a conical tapered end 11, wherein the first end 101 of this preferred embodiment is a conical first tapered end 11.

A grip portion 13 is disposed at an outer periphery between the first end 101 and the second end 102 of the main body 10, and the grip portion 13 has a predetermined length such as 50 cm-100 cm which is convenient for a user's hand to grip.

In FIG. 3C, a plurality of clip slots 21 use the center of the main body 10 as an axis 14, and an inner side end of the clip slot 21 is formed into a closed end 211, and the clip slots 21 are radially distributed at the periphery of the main body 10, and the axis (X-axis) is penetrated through both ends of the main body 10, and each clip slot 21 has at least a cable management hole 22 formed therein, and the outer end is extended to a surface of the grip portion 13 to form an opening 24. This is the major difference from the horizontal pocket as disclosed in U.S. Pat. Nos. 7,959,113 and 7,600,721. The radial clip slots 21 of the present invention are symmetrically and radially distributed with respect to the axis 14, so that the network cables C can be distributed uniformly to facilitate the combing operation and the clip slots 21 and the grip portion 13 are skillfully integrated, so that the outer jacket half is no longer required. The clip slot 21 has three cable management holes 22 formed therein, and the cable management hole 22 is formed by the inner wall surface of the clip slot 21 into a serrated form 23. In addition, a plurality of fixing wings 31 is formed between the plurality of clip slots 21, and each fixing wing 31 is manufactured into a solid member or a hollow member 32 as shown in FIG. 3D, and the periphery of the axis 14 of the main body 10 may be formed as a hollow body 33 to reduce the weight of the main body 10 and lower the material cost.

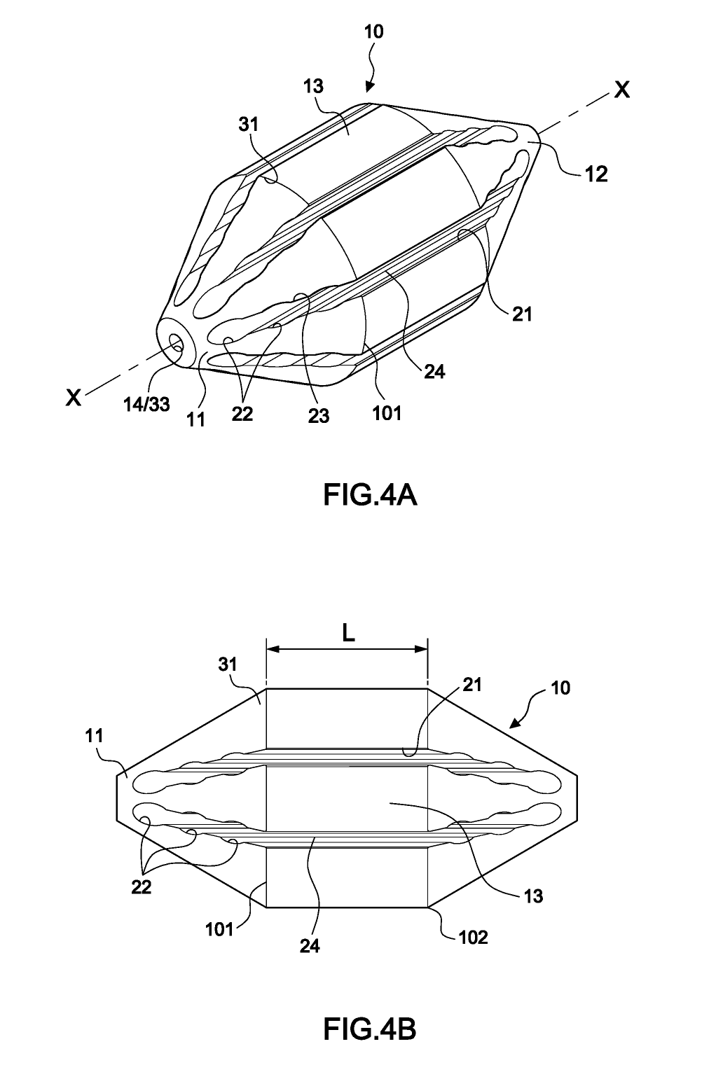

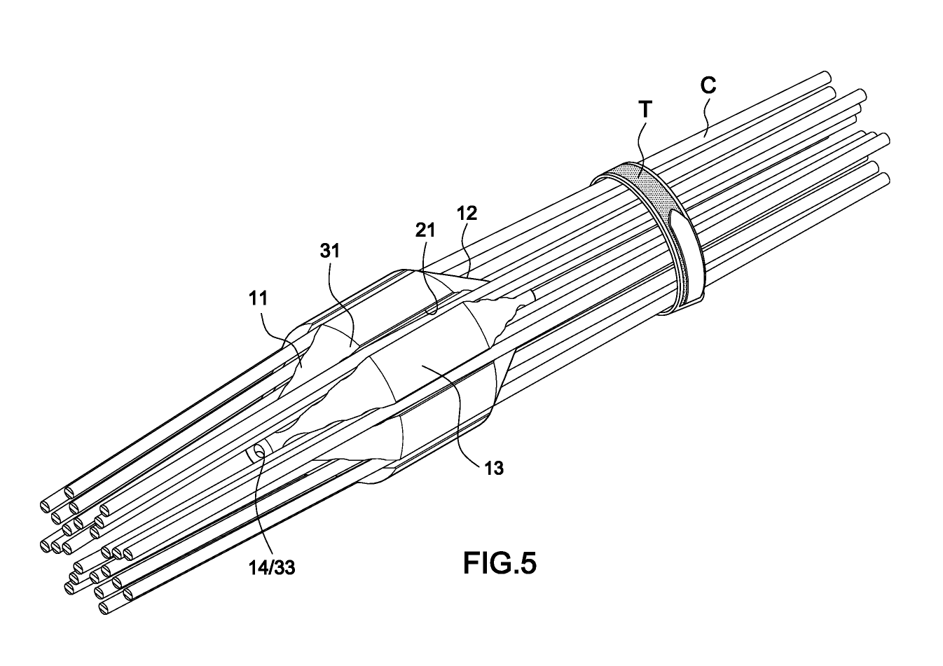

With reference to FIGS. 4A and 4B for a network cable management device in accordance with the second preferred embodiment of the present invention, this preferred embodiment is substantially the same as the first preferred embodiment, except that a second tapered end 12 is formed on a side end of the main body 10 and opposite to the first tapered end 11 and configured to be symmetrical with respect to the first tapered end 11, such that when the main body 10 performs a combing operation of the network cables C repeatedly, a smaller resistance will be produced.

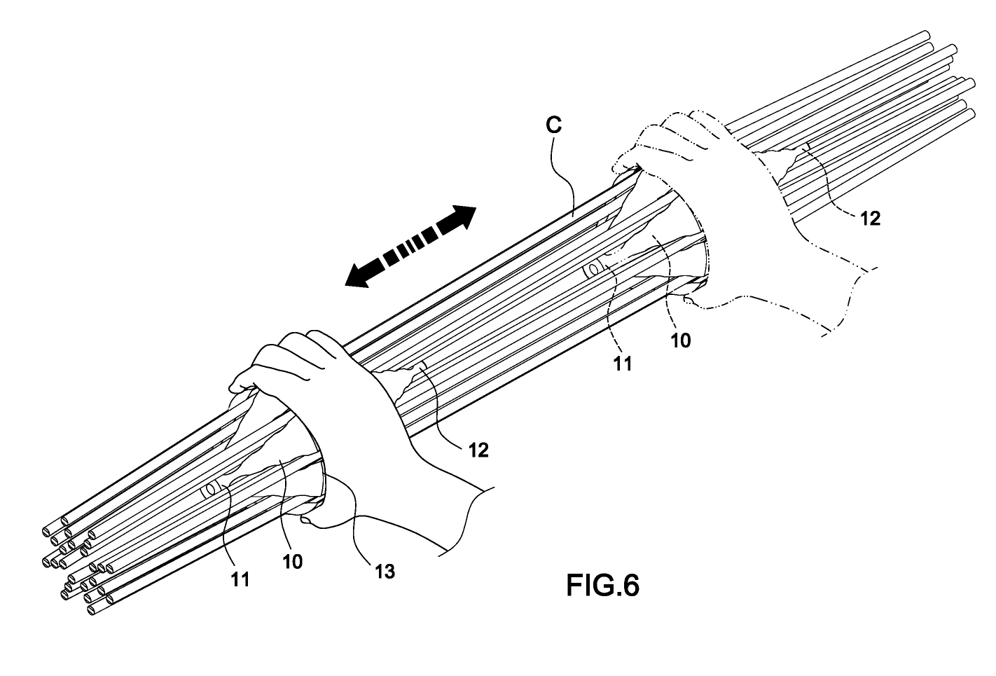

With reference to FIG. 5 for an application of the second preferred embodiment of the present invention, a user may embed the network cable C from the opening 24 of each respective clip slot 21 into each respective cable management hole 22. In this preferred embodiment, each clip slot 21 has three cable management holes 22 formed therein, so that each clip slot 21 can receive three network cables C. Since each clip slot 21 is penetrated through the main body 10 axially (in the X-X direction), and each cable management hole 22 in the clip slot 21 is configured correspondingly, so that the network cables C embedded into the cable management holes 22 will not be staggered or tangled. In addition, both ends of the main body 10 are conical first tapered end 11 and second tapered end 12, and the cable management holes 22 in the clip slot 21 are parallel and to each other and tapered towards the axis 14, so that the three network cables C in each clip slot 21 are convergent towards the axis 14. In other words, after the network cables C are passed through the first tapered end 11 and the second tapered end 12 of the main body 10, the network cables will be parallel to the axis 14 and will gather together. Since the middle of the network cables C has a smaller gap, therefore users may tie the cables by a cable tie T easily and may arrange the network cables neatly to prevent the network cables from tangled or scattered messily.

With reference to FIG. 6 for combing the cables in accordance with the second preferred embodiment of the present invention, the network cables C in an engine room may be moved sometimes and may be tangled with each other after a certain period of time, so that cable management device of the present invention may be used to comb the cables. Before the combing operation it is necessary to remove the cable tie T originally used for tying the network cables C, and then move the main body 10 slowly from the host to a remote end, so that the network cables C are combed by the first tapered end 11 or second tapered end 12 of the main body 10 and arranged neatly, and then a user may comb the cables section by section before tying the cables by the cable tie T in order to untangle the messy cables.

In the present invention, the clip slots 21 are radially distributed at the periphery of the main body 10, and penetrated through both ends of the main body 10 axially (in the X-X direction), so that the network cables C can be distributed uniformly, and the application does not require the removal of the plug or connector of the cable, but any part of the cable C can be embedded into the cable management hole 22 of each clip slot 21, so that many network cables C can be arranged neatly. Further, one or both ends of the present invention is manufactured into a conical tapered end, so that when the network cable C is put into the cable management hole 22 at the first tapered end 11 or second tapered end 12, the network cable C will be converged automatically towards the axis 14. Since the middle of the network cables C has a smaller gap, therefore the cables can be tied by a cable tie T conveniently to prevent them from being tangled or scattered randomly. In the present invention, the grip portion 13 is disposed at the outer periphery of the main body and provided for facilitating users to grip. One or both ends of the grip portion 13 are manufactured into a tapered end 11/12, so that a smaller resistance is produced when moving the network cables C, and the combing operation of the network cables C can be performed easily. In addition, the present invention skillfully integrate the clip slots 21 with the grip portion 13 to overcome the drawbacks of the conventional hub without requiring the outer jacket half Obviously, the invention provides a convenient and labor-saving effect.

What is claimed is:

1. A network cable management device, comprising:
a main body, being a columnar body, and having a first end and a second end configured to be corresponsive to the first end, and at least one of the first and second ends being a conical first tapered end;
a grip portion, disposed at the outer periphery between the first end and the second end of the main body, and having a predetermined length provided for being held by a user's hand; and
a plurality of clip slots, using the center of the main body as the axis, and having a closed side end and being radially distributed at the periphery of the main body and axially penetrated through both ends of the main body, and each clip slot at least having a cable management hole, and an outer end extended to a surface of the grip portion to form an opening;
thereby, the network cables with a predetermined quantity are embedded into the cable management hole through the openings of the clip slots respectively, and the network cables can be arranged without being staggered, and the first tapered end keeps the network cable to be convergent towards the axis.

2. The network cable management device of claim 1, further comprising a second tapered end disposed on an opposite end of the first tapered end of the main body and configured to be symmetrical with respect to the first tapered end, and a relatively smaller resistance is produced when the main body performs a combining operation of the network cables repeatedly.

3. The network cable management device of claim 1, further comprising a plurality of fixing wings formed between the plurality of clip slots, and each fixing wing being made into a hollow member, and the axis of the main body also forming a hollow body to reduce the weight and the material cost of the main body.
